(19) United States
(12) Patent Application Publication
(10) Pub. No.: US 2020/0218198 A1
(43) Pub. Date: Jul. 9, 2020

(54) MOVEMENT CONTROL OF HOLOGRAPHIC OBJECTS WITH CROWN MOVEMENT OF A WATCH DEVICE

(71) Applicant: INTERNATIONAL BUSINESS MACHINES CORPORATION, ARMONK, NY (US)

(72) Inventors: ERIC V. KLINE, ROCHESTER, MN (US); SARBAJIT K. RAKSHIT, KOLKATA (IN)

(21) Appl. No.: 16/240,226

(22) Filed: Jan. 4, 2019

(51) Int. Cl. G03H 1/04; G06F 3/0362; G04G 21/00; G04B 19/28; G06F 3/0482

(52) U.S. Cl. CPC G03H 1/0443; G06F 3/0362; G03H 2001/0428; G04B 19/283; G06F 3/0482; G04G 21/00

(57) ABSTRACT

A method includes providing wireless communication between a device having a holography module and a watch. The watch is being worn by a user and has sensors. The holography module outputs one or more holographic objects in three-dimensional space. User's selection of one of the holographic objects is detected by the watch. Direction of rotation of a crown of the watch is detected and rotational speed of the crown of the watch is measured by the watch. The watch communicates to the holography module the direction of rotation of the crown and the rotational speed of the crown. The holography module changes position of the selected holographic object by moving the selected holographic object. Direction of movement of the selected holographic object corresponds to the direction of rotation of the crown. Speed of the movement of the selected holographic object corresponds to the rotational speed of the crown.

### BACKGROUND

The present invention relates to holographic object interaction and, more specifically, movement control of holographic objects with the crown movement of a watch device.

Holographic three-dimensional (3D) objects can be projected in mid-air. Users can interact with the holographic objects with finger touch and/or various gestures. Holographic projectors installed in a surrounding can collaborate with each other to project 3D holographic objects in a 3D space. Typically, collaboration of these holographic projectors enables movement of various 3D holographic objects from one point to another within a holographic display. Holographic objects can be used for gaming, simulations of various 3D models, assembling of holographic particles to create a larger 3D model, and the like. For example, a computer designed 3D holographic model may be presented to a team of designers, allowing one, several, or each of the team members to walk around the model, relate to it and/or manipulate it. For instance, in a model of a mechanical part, such as the envelope of a new cellular phone, where the display is a touch screen, one designer can suggest modifying lighting of the display, and another will comment on the results of the modification and suggest adding real buttons and preset that instantly. Similarly, a single designer can look at the same detail from different angles. While reviewing a design, a member of the team can point to a specific object within the holographic model (with a dedicated pen or with his finger) and move it from one point in space to another. In this scenario, enabling precise movement of holographic objects would be advantageous. For example, a group of users might use a projector-based holographic system to create a large 3D holographic model by assembling different holographic objects and moving them around. Any small deviation in the movement of holographic objects can lead to misalignment or inappropriate positioning of objects within the 3D model.

What is needed is a method enabling a high level of precision with respect to the movement of various 3D holographic objects in an enclosed area.

### SUMMARY

Embodiments of the present invention are directed to a computer-implemented method for controlling movement of holographic objects. A non-limiting example of the computer-implemented method includes providing wireless communication between a device having a holography module and an external watch device. The external watch device is being worn by a user and has one or more sensors. The holography module outputs one or more holographic objects in three-dimensional space. User's selection of one of the holographic objects is detected by the watch device. Direction of rotation of a crown of the watch device is detected and rotational speed of the crown of the watch device is measured by the watch device. The watch device communicates to the holography module the direction of rotation of the crown and the rotational speed of the crown. The holography module changes position of the selected holographic object within the three-dimensional space by moving the selected holographic object. Direction of movement of the selected holographic object corresponds to the direction of rotation of the crown. Speed of the movement of the selected holographic object corresponds to the rotational speed of the crown.

Embodiments of the present invention are directed to a system for controlling movement of holographic objects. A non-limiting example of the system includes a memory having computer-readable instructions and one or more processors for executing the computer-readable instructions. The computer-readable instructions include providing wireless communication between a device having a holography module and an external watch device. The external watch device is being worn by a user and has one or more sensors. The holography module outputs one or more holographic objects in three-dimensional space. User's selection of one of the holographic objects is detected by the watch device. Direction of rotation of a crown of the watch device is detected and rotational speed of the crown of the watch device is measured by the watch device. The watch device communicates to the holography module the direction of rotation of the crown and the rotational speed of the crown. The holography module changes position of the selected holographic object within the three-dimensional space by moving the selected holographic object. Direction of movement of the selected holographic object corresponds to the direction of rotation of the crown. Speed of the movement of the selected holographic object corresponds to the rotational speed of the crown.

Embodiments of the invention are directed to a computer-program product for controlling movement of holographic objects, the computer-program product including a computer-readable storage medium having program instructions embodied therewith. The program instructions are executable by a processor to cause the processor to perform a method. A non-limiting example of the method includes providing wireless communication between a device having a holography module and an external watch device. The external watch device is being worn by a user and has one or more sensors. The holography module outputs one or more holographic objects in three-dimensional space. User's selection of one of the holographic objects is detected by the watch device. Direction of rotation of a crown of the watch device is detected and rotational speed of the crown of the watch device is measured by the watch device. The watch device communicates to holography module the direction of rotation of the crown and the rotational speed of the crown. The holography module changes position of the selected holographic object within the three-dimensional space by moving the selected holographic object. Direction of movement of the selected holographic object corresponds to the direction of rotation of the crown. Speed of the movement of the selected holographic object corresponds to the rotational speed of the crown.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an exemplary diagram of a possible data processing environment in which illustrative embodiments may be implemented;

FIG. 2 shows a holographic system with user remote object interaction, in accordance with an embodiment of the present invention;

FIG. 3 depicts a holographic object movement control system, in accordance with an embodiment of the present invention;

FIG. 4 is a block diagram of a mobile device, in accordance with an alternative embodiment of the present invention;

FIG. 5 is a perspective view of one example of a watch-type mobile device, in accordance with embodiments of the present invention;

FIG. 6 is a conceptual diagram of a holographic object presented through a holography module as shown in FIG. 5, in accordance with embodiments of the present invention;

FIGS. 7A and 7B are diagrams illustrating a user capability of controlling the movement of holographic objects using a watch device, in accordance with embodiments of the present invention;

FIG. 8 is a conceptual diagram illustrating user-controlled movement of a holographic object in 3D space, in accordance with embodiments of the present invention;

FIG. 9 shows a flow diagram of a method for controlling the movement of holographic objects, in accordance with embodiments of the present invention; and

FIG. 10 is a block diagram of a computer system for implementing some or all aspects of the holographic object movement control system, according to some embodiments of this invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, the methods and systems described below may advantageously be employed to enable multiple users of a holographic system to interact with and manipulate 3D holographic objects simultaneously or separately using an external watch device. The holographic system may include cameras and sensors used to capture interaction behavior of participating users from various angles to identify if a user is using a finger gesture to select and interact (i.e. selection, touch, etc.) with holographic objects. Using image analysis techniques, the holographic system extrapolates a finger direction of the user to identify the holographic objects intended to be selected. Accordingly, in some embodiments, the holographic projection system plots a holographic intersection line from the fingertip to the holographic object of a defined color of the user to signal the selection. Once the object is selected, the user utilizes his/her watch device to manipulate the object. Each user may be granted specific actions and duration for manipulation of the object. Accordingly, other users can take control of the holographic object navigation and interaction using their own watch devices.

In an embodiment of the present invention, a method for controlling movement of holographic objects, establishes a communication mechanism between a holography module and a wearable device. The holography module is configured to output holographic objects and may be hosted by a computer device or a mobile device. The wearable device, for example, a smartwatch, can exchange data with the holography module (or otherwise cooperate with the holography module). According to embodiments of the present invention, the watch device enables users to take control of the holographic object navigation and interaction. In other words, the watch device allows users to move any selected holographic object along any axis within the three-dimensional space.

In an embodiment of the present invention, the disclosed system enables users to rotate a crown of their watch device to control movements of the 3D holographic object. For example, if a user seeks to move a 3D holographic object, that user may be given the opportunity to control the linear movement of the 3D holographic object by rotating a crown of the watch device in a corresponding direction.

The system of the present invention also allows control of the linear speed of the 3D holographic object movement. For example, in one embodiment, the linear speed of the 3D holographic object can be controlled by the rotational speed of the watch crown. It should be noted that it may not be possible for various users to manually touch and control the holographic object directly. The users control a variety of 3D holographic objects for activities such as, but not limited to, an interactive business meeting, multi-player gaming, and the like.

It will be recognized that users of the holographic object movement control system of the present invention can dynamically change the linear direction movement of a holographic object in three-dimensional space by applying pre-configured pressure ranges on the crown of their watch devices.

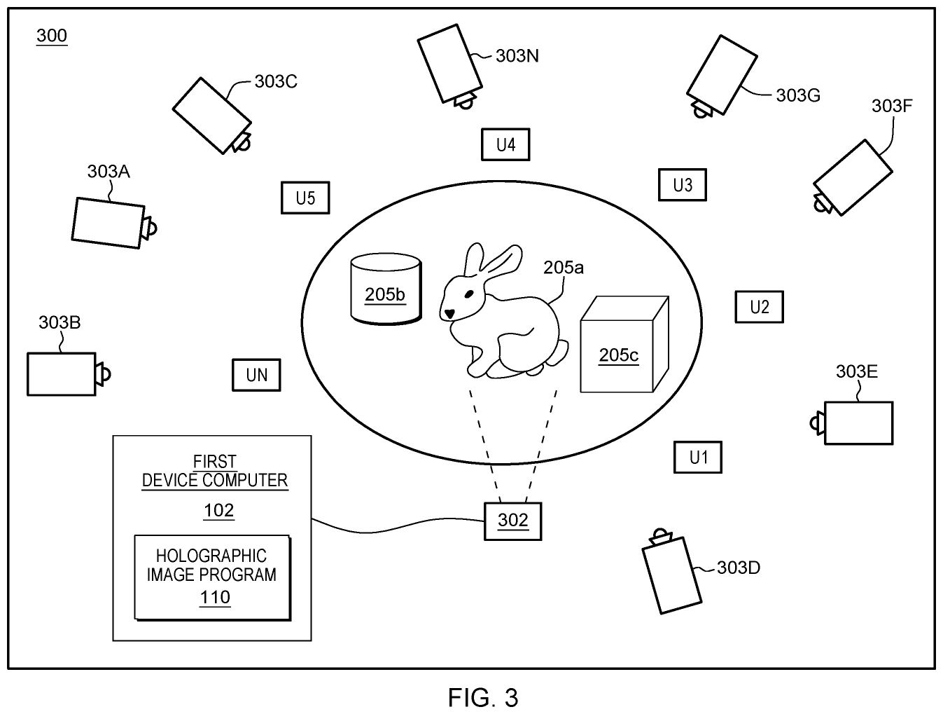

FIG. 3 depicts an exemplary holographic object movement control system, in accordance with an embodiment of the present invention. The system 300 is in an environment in which the holographic objects are to be manipulated in. The environment may be a conference room, meeting room or other physical location.

Within the holographic object movement control system 300 is a projector 302 which projects at least one 3D holographic object 205a-205c midair from the table or surface. In some embodiments, the 3D holographic objects may be produced by one or more mobile devices, as described below. Also present within the holographic object movement control system 300 is a plurality of cameras 303a-303n. The cameras 303a-303n observe and capture images of the users U1-UN for identification of selected holographic object from multiple angles. It should be noted that the placement of the cameras 303a-303n and the projector 302 may be present within the environment in locations other than what is shown in FIG. 3.

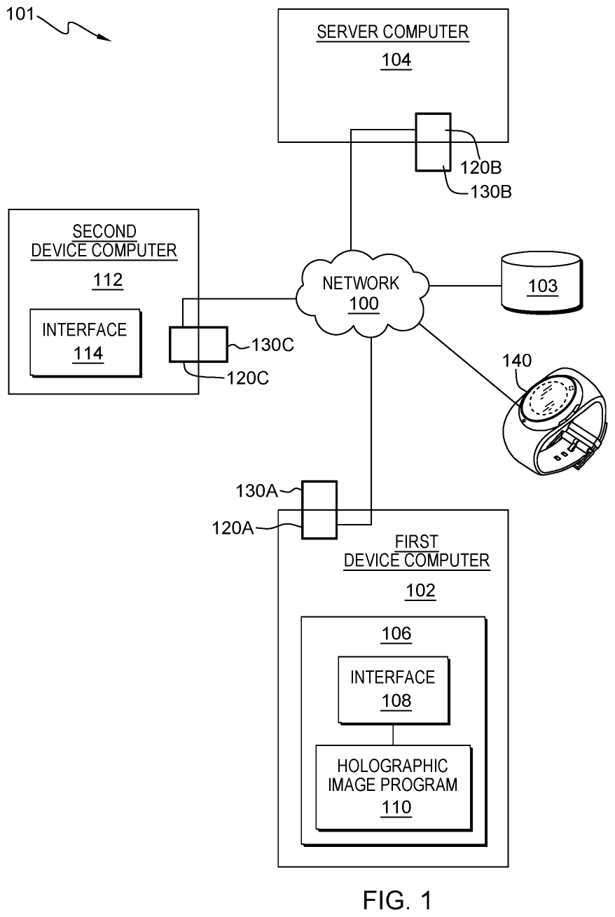

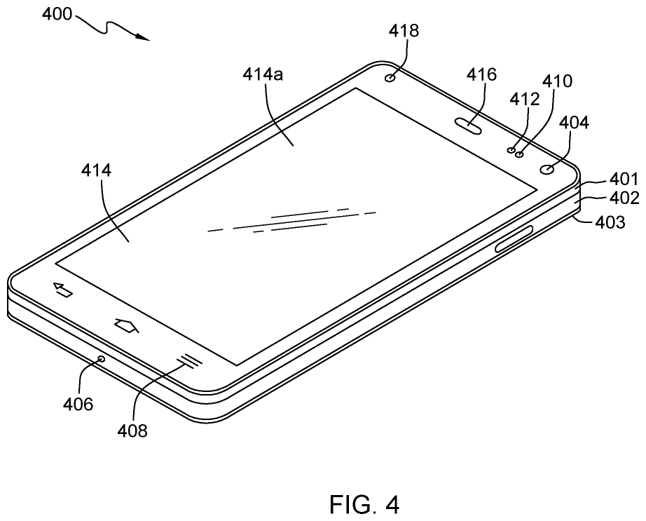

A computer, such as first device computer 102, and a wearable watch device 140, such as a smartwatch, as shown in FIG. 1, may also be present within the holographic object movement control system 300. The first device computer 102 may define hologram properties, define user control policy, process object manipulation information received from wearable devices and the like. The watch device 140 may allow the user to control manipulation of the 3D holographic object. The projector 302 and the plurality of cameras 303a-303n can each contain a second device computer 112 as shown in FIG. 1. Alternatively, the projector 302 and the plurality of cameras 303a-303n can each be contained within a mobile device 400 shown in FIG. 4. The plurality of cameras 303a-303n, the projector 302, the first device computer 102 and the watch device 140 may be connected through a network 100. Furthermore, a server computer 104 may be present within the network 100. The first device computer 102, second device computer 112 and server computer 104 may access a repository 103 through a network 100. The repository 103 may contain control policy of 3D holographic objects, user profiles, pre-configured pressure ranges applied to watch's crowns, ratios between the speed of rotational motion of a crown and the speed of linear motion of a selected holographic object and other information related to manipulation and relocation of 3D holographic objects.

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 101 is a network of computers in which illustrative embodiments may be implemented. Network data processing system 101 contains network 100, which is the medium used to provide communication links between various devices and computers connected together within network data processing system 101. Network 100 may include connections, such as wire, wireless communication links, or fiber optic cables.

In the depicted example, a first device computer 102, a second device computer 112, a repository 103, a watch device 140, and a server computer 104 connect to network 100. In other exemplary embodiments, network data processing system 101 may include additional client or device computers, mobile devices, storage devices or repositories, server computers, and other devices not shown.

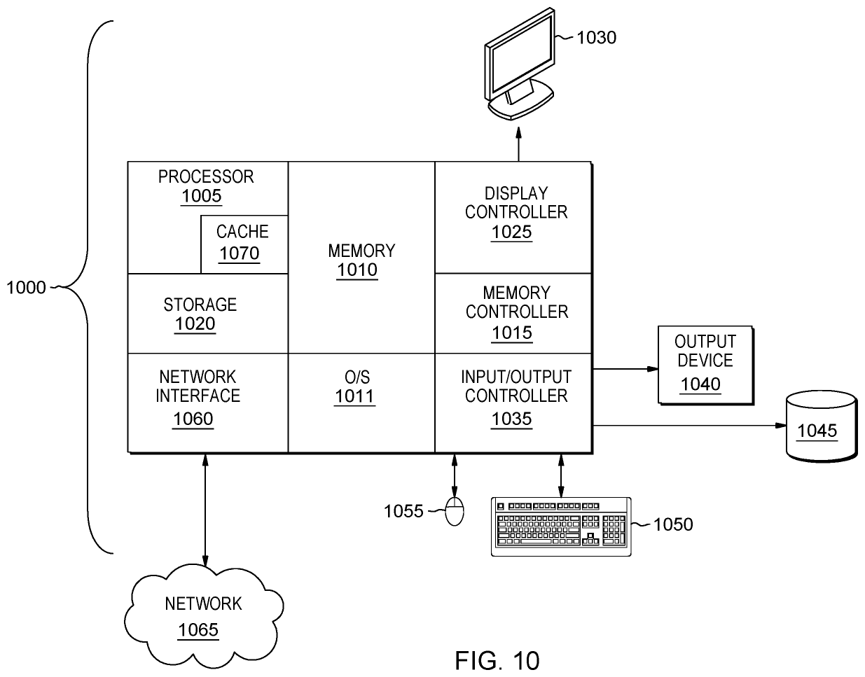

The first device computer 102 may contain a holography module 106. Holography module 106 may contain an interface 108, which may accept commands and data entry from a user. The commands may be regarding hologram properties, policy and priority of users regarding the manipulation of 3D holographic objects. The interface can be, for example, a command line interface, a graphical user interface (GUI), a natural user interface (NUI) a touch user interface (TUI), a web-based interface, or an application programming interface for defining the hologram interaction policies. The holography module 106 preferably includes holographic image program 110. While not shown, it may be desirable to have the holographic image program 110 be present on the server computer 104, the second device computer 112 or the external watch device 140. The first device computer 102, server computer 104 and second device computer 112 each includes a set of internal components 120a, 120b and 120c, respectively, and a set of external components 130a, 130b and 130c, respectively further illustrated in FIG. 10.

The second device computer 112 may contain an interface 114, which may accept commands and data entry from a user. The commands may be regarding holographic image projection. The interface can be, for example, a command line interface, a graphical user interface (GUI), a natural user interface (NUI) or a touch user interface (TUI).

In the depicted example, server computer 104 provides information, such as boot files, operating system images, and applications to the first device computer 102 and/or the second device computer 112. Server computer 104 can compute the information locally or extract the information from other computers on network 100. The server computer 104 may contain the holography module 106.

Program code and programs such as holographic image program 110 may be stored on at least one of one or more computer-readable tangible output storage devices 1040 shown in FIG. 10, on at least one of one or more portable computer-readable tangible storage devices 1045 as shown in FIG. 10, or on the storage unit 103 connected to network 100, or may be downloaded to a first device computer 102, a second device computer 112 or server computer 104, for use. For example, program code and programs such as holographic image program 110 may be stored on at least one of one or more storage devices 1045 on server computer 104 and downloaded to the first device computer 102, the second device computer 112 or watch device 140 over network 100 for use. Alternatively, server computer 104 can be a web server, and the program code, and programs such as holographic image program 110, may be stored on at least one of the one or more storage devices 1045 on server computer 104 and accessed by the first device computer 102 and/or the second device computer 112. In other exemplary embodiments, the program code, and programs such as holographic image program 110 may be stored on at least one of one or more computer-readable storage devices 1045 on a first device computer 102, a second device computer 112 or distributed between two or more servers.

In the depicted example, network data processing system 101 is the Internet with network 100 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 101 also may be implemented as a number of different types of networks, such as, for example, an intranet, local area network (LAN), or a wide area network (WAN). FIG. 1 is intended as an example, and not as an architectural limitation, for the different illustrative embodiments.

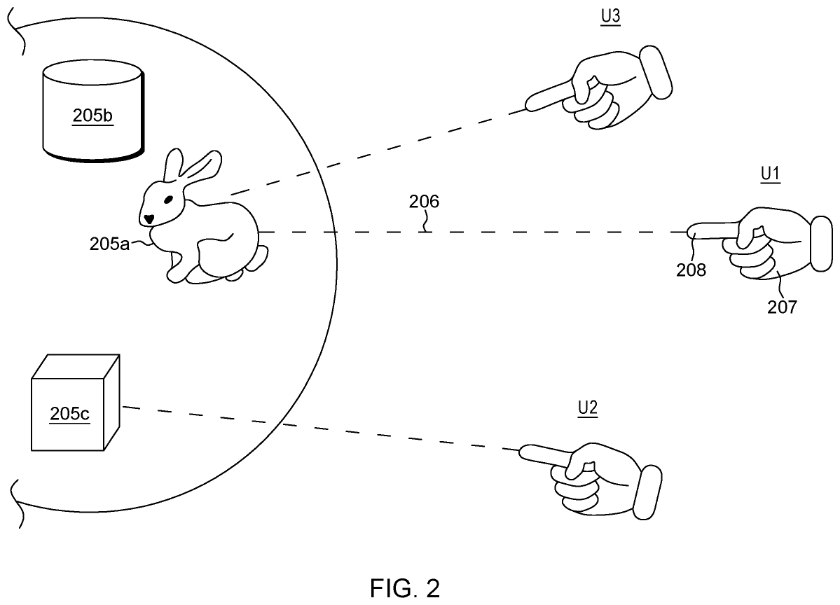

Referring back to FIG. 3, it depicts a holographic object movement control system 300, where at least one holographic projector 302 and a plurality of cameras 303a-303n are installed in the surrounding 3D space to plot the holographic objects being projected by a projector 302 relative to the users U1-UN within the holographic object movement control system 300. Cameras 303a-303n installed in the environment identify users using their finger with the intention of selecting the 3D holographic object 205a-205c. The holographic object movement control system 300, via the first device computer 110 and cameras 303a-303n, identifies an extrapolated finger 208 direction of a hand 207 of the user (as shown in FIG. 2) and if the finger direction of the user intersects with any 3D holographic objects 205a-205c. Other sensors may also be used to extrapolate finger direction within the holographic object movement control system 300. When a user is controlling the movement of the 3D holographic object using his/her watch device 140, the object or portion of the object may be a color assigned to the user. Referring to FIG. 2, the extrapolated finger direction would identify both users U1 and U3 as intersecting with the 3D holographic object 205a in the shape of a bunny and extrapolated finger direction of user U2 as intersecting with the 3D holographic object 205c of a cube.

Prior to a user controlling the movement of a 3D holographic object, a hologram interaction policy may be determined. The hologram interaction policy includes a definition of the shape of the 3D holographic object (i.e. square, rectangular, bunny, etc.); definition of controls on each side of object that users can interact (i.e., touch interface with areas or buttons); definition of operations that only one user can perform at time (i.e., rotation or movement of the object); and definition of a duration of time for specific operations.

A user control policy mapping may also be determined. The user control policy may define user hierarchy for control of objects. For example, priority manager=1, team lead=2, other member queue on first come basis. Users will be queued until the operation is complete. Each user has a defined color mapping such that when they select, manipulate or move an object, the line from the user to the object is represented as active by showing the color for that user. The line could be configured to pulse or stay solid.

In certain embodiments, holographic objects produced by the holographic object movement control system 300 may be rendered by one or more mobile devices instead of, or in cooperation with stationary devices, such as holographic projectors 302, digital TVs, desktop computers, and the like. Mobile devices presented herein may be implemented using a variety of different types of devices. Examples of such devices include cellular phones, smartphones, user equipment, laptop computers, digital broadcast terminals, personal digital assistants (PDAs), portable multimedia players (PMPs), navigators, portable computers (PCs), slate PCs, tablet PCs, ultra-books, wearable devices (for example, smart watches, smart glasses, head-mounted displays (HMDs)), and the like. By way of non-limiting example only, further description will be made with reference to particular types of mobile devices. However, such teachings apply equally to other types of devices, such as those types noted above.

Reference is now made to FIG. 4, where FIG. 4 is a conceptual view of one example of a mobile device related to another embodiment of the present invention. Implementing all of the illustrated components is not a requirement, and that greater or fewer components may alternatively be implemented. The mobile device 400 is described with reference to a bar-type terminal body. However, the mobile device 400 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile device (for example, bar-type, watch-type, glasses-type, and the like). However, such teachings with regard to a particular type of mobile device will generally apply to other types of mobile devices as well.

The mobile device 400 will generally include a case (for example, frame, housing, cover, and the like) forming the appearance of the device. In this embodiment, the case is formed using a front case 401 and a rear case 402. Various electronic components are incorporated into a space formed between the front case 401 and the rear case 402. At least one middle case may be additionally positioned between the front case 401 and the rear case 402.

The display unit 414 is shown located on the front side of the device body to output information. As illustrated, a window 414a of the display unit 414 may be mounted to the front case 401 to form the front surface of the device body together with the front case 401.

In some embodiments, electronic components may also be mounted to the rear case 402. Examples of such electronic components include a detachable battery, an identification module, a memory card, and the like. Rear cover 403 is shown covering the electronic components, and this cover may be detachably coupled to the rear case 402. Therefore, when the rear cover 403 is detached from the rear case 402, the electronic components mounted to the rear case 402 are externally exposed.

If desired, the mobile device 400 may include a waterproofing unit for preventing the introduction of water into the terminal body. For example, the waterproofing unit may include a waterproofing member which is located between the window 414a and the front case 401, between the front case 401 and the rear case 402, or between the rear case 402 and the rear cover 403, to hermetically seal an inner space when those cases are coupled.

The mobile device 400 may be provided with the display unit 414, the holography module 416, the proximity sensor 410, the illumination sensor 412, the projector module 418, the camera 404, the manipulating unit 408, the microphone 406, and the like.

FIG. 4 depicts certain components as arranged on the mobile device. However, alternative arrangements are possible and within the teachings of the instant disclosure. Some components may be omitted or rearranged. For example, the manipulation unit 408 may be located on another surface of the device body.

The display unit 414 outputs information processed in the mobile device 400. The display unit 414 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof. The display unit 414 may be implemented using two display devices, which can implement the same or different display technology. For instance, a plurality of the display units 414 may be arranged on one side, either spaced apart from each other, or these devices may be integrated, or these devices may be arranged on different surfaces.

The manipulation unit 408 is an example of the user input unit, which may be manipulated by a user to provide input to the mobile device 400. The manipulation unit 408 may also be commonly referred to as a manipulating portion and may employ any tactile method that allows the user to perform manipulation such as touch, push, scroll, or the like. The manipulation unit 408 may also employ any non-tactile method that allows the user to perform manipulation such as proximity touch, hovering, or the like.

FIG. 4 illustrates the manipulation unit 408 as a touch key, but possible alternatives include a mechanical key, a push key, a touch key, and combinations thereof. Input received at the manipulation unit 408 may be used in various ways. For example, the manipulation unit 408 may be used by the user to provide an input to a menu, home key, cancel, search, or the like.

The microphone 406 is shown located at an end of the mobile device 400, but other locations are possible. If desired, multiple microphones may be implemented, with such an arrangement permitting the receiving of stereo sounds.

Meanwhile, the mobile device 400, according to one embodiment of the present invention, may further include a projector module 418 and/or a holography module 416. The projector module 418 may perform an image projector function using the mobile device 400. The projector module 418 may display an object identical to or partially different from the image displayed on the display 414 on an external screen or wall according to a control signal of a controller.

The projector module 418 may be classified into a CRT (cathode ray tube) module, LCD (liquid crystal display) module and a DLP (digital light processing) module in accordance with a display device type. Particularly, the DLP module may enable an image, which is generated by reflecting light generated from the light source on a DMD (digital micro-mirror device) chip, to be enlarged and projected. It may be advantageous in reducing the size of the projector module 418.

Preferably, the projector module 418 can project the object toward a prescribed direction. It is apparent that the projector module 418 may be disposed at any position of the mobile device 400, if necessary. The holography module 416 can include a holography storage unit, a holography output unit and, if necessary, a holography reflecting unit. The holography module 416 can be configured to output a 3D holographic object on a preset space.

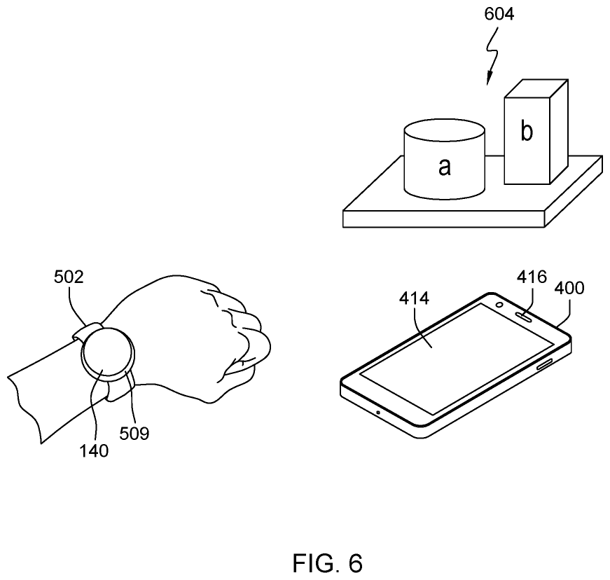

Hereinafter, a structure of the holography module 416 and a method of projecting a holographic object will be described in greater detail with reference to FIGS. 6 to 9. A location and an object-projection direction of the holography module 416 can be identical to those of the above-mentioned projector module 418.

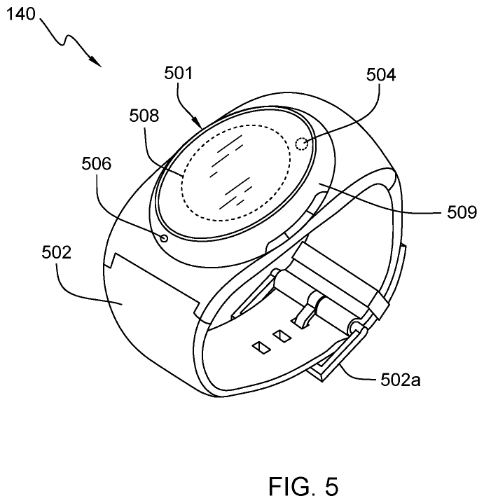

FIG. 5 is a perspective view of one example of a watch-type mobile device 140 related to various embodiments of the present invention. Referring to FIG. 5, a watch device 140 may include a main body 501 with a display unit 508 and a band 502, which is configured to be wearable on the wrist, connected to the main body 501. In general, the watch device 140 may be configured to include features that are the same or similar to that of the mobile device 400 shown in FIG. 4.

The main body 501 may include a case forming the appearance of the device. The watch device 140 is configured to perform wireless communication and an antenna for the wireless communication can be installed in the main body 501. The performance of the antenna may be improved using the case. For example, a case including a conductive material may be electrically connected to the antenna to extend a ground area or a radiation area.

The display unit 508 is located at the front side of the main body 501 in order to output information. In some cases, the display unit 508 and/or a crown 509 includes of the watch device 140 may include a touch sensor. Here, the touch sensor may serve as a user input unit. When a touch is input to the display unit 508 and/or the crown 509, the touch sensor may be configured to sense this touch and a controller of the device 140, for example, may generate a control command or other signal corresponding to the touch. The content which is input in a touching manner may be a text or numerical value.

The touch sensor may be configured in a form of a film having a touch pattern, disposed between the crown 509 and a display, for example. Alternatively, the touch sensor may be integrally formed with the crown 509. For example, the touch sensor may be disposed within the crown 509.

The main body 501 may include a camera 504, and a microphone 506. When the display unit 508 is implemented as the touchscreen, it may work as the user input unit, whereby additional function keys may be omitted from the main body 501.

The band 502 is commonly worn on the user's wrist and may be made of a flexible material for facilitating wearing of the device. As one example, the band 502 may be made of leather, rubber, silicon, synthetic resin or the like. The band 502 may also be configured to be detachable from the main body 501. Accordingly, the band 502 may be replaceable with various types of bands according to a user's preference.

In some cases, the band 502 may be used for extending the performance of the antenna. For example, the band may include therein a ground extending portion electrically connected to the antenna to extend a ground area. The band 502 may include fastener 502a. The fastener 502a may be implemented into a buckle type, a snap-fit hook structure, a Velcro® type, or the like, and include a flexible section or material. The drawing illustrates an example that the fastener 502a is implemented using a buckle.

Embodiments related to control methods, which can be implemented in the above-mentioned mobile terminal, are described with reference to the accompanying drawings. It will be apparent to those skilled in the art that the present invention may be embodied in other specific forms without departing from the spirit and essential characteristics of the invention. According to an embodiment of the present invention, a controlling method for movement of holographic objects is provided. The embodiments of the present invention are mainly focused on examples of interconnection between the mobile device 400 and the watch-type mobile device 140, by which embodiments of the present invention are non-limited.

According to an embodiment of the present invention, as shown in FIG. 6, the holographic object 604 is projected onto an empty space over the front surface of the display unit 414 of the mobile device 400. In particular, the holographic object 604 is projected onto the empty space over the front surface of the display unit 414 of the mobile device 400 through the holography module 416 of the mobile device 400. In this instance, the holographic object 604 can be an image associated with the launch screen output through the display unit 414. For instance, if a map is output through the display unit 414, the holographic object 604 can correspond to a 3-dimensional object of the map. In another non-limiting example, a holographic object for the morphology of a patient may be used in the field of medicine or a 3-dimensional content may be used in the field of multimedia. Moreover, embodiments of the present invention may be extended to a case that a 3-dimensional architectural model is an output as a holographic object in the architectural field.

FIG. 6 is a conceptual diagram of a holographic object 604 implemented through the holography module 416 as shown in FIG. 4. In the embodiments described with reference to the following drawings including FIG. 6, assume that the mobile device 400 and the watch device 140 are interconnected with each other.

The holographic object 604, which can be implemented through the holography module 416, may include a 3-dimensional (3D) stereoscopic image. Stereoscopic imaging, which provides different images to both eyes respectively, uses a principle that the human being feels stereoscopic when viewing an object with two eyes. In particular, the two eyes of the human being view different monoscopic images when viewing the same object due to a distance therebetween. The different monoscopic images are transferred to the brain through the retina and unified (combined) in the brain such that depth and reality of a stereoscopic image can be felt. Therefore, although slightly different in persons, binocular disparity due to the distance between both eyes brings about stereoscopic feeling. The stereoscopic imaging is a method of displaying an image using the binocular disparity.

According to embodiments of the present invention, users can manipulate/control the movement of the holographic object 604. In one embodiment, the watch device 140 may be configured to sense rotation of the crown 509 and/or to sense pressure applied to the crown of the watch device 140. In particular, if the crown 509 of the watch device 140 is rotated clockwise by a user, the holographic object movement control system 300 can move the holographic object 604 away from the user via the holography module 416, and if the crown 509 of the watch device 140 is rotated counterclockwise by the user, the holographic object movement control system 300 can move the holographic object 604 towards the user via the holography module 416, for example.

In this instance, as mentioned in the foregoing description, the holography module 416 disposed at the mobile device 400 can output the holographic object 604 through the empty space over the front surface of the display unit 414. Here, the touch sensor of the watch device 140 may be configured to sense the rotation of the crown portion 509. In one embodiment, the touch sensor may include a rotation rib configured to sense the movement of the crown portion 509 and a sensing switch configured to generate an electrical signal according to the movement of the crown 509. The electrical signal may form a control command distinguished according to the different directions of the crown movement. In other words, the rotational motion of the crown portion 509 of the watch device 140 generates an electrical signal transmitted to the holographic object movement control system 300. In response to receiving such signal, the holographic object movement control system 300 produces linear motion of the holographic object, such as the holographic object 604, for example. In some embodiments, a ratio between the speed of rotational motion of the crown 509 and the speed of linear motion of the holographic object 604 can be dynamically configured by a user, as described below.

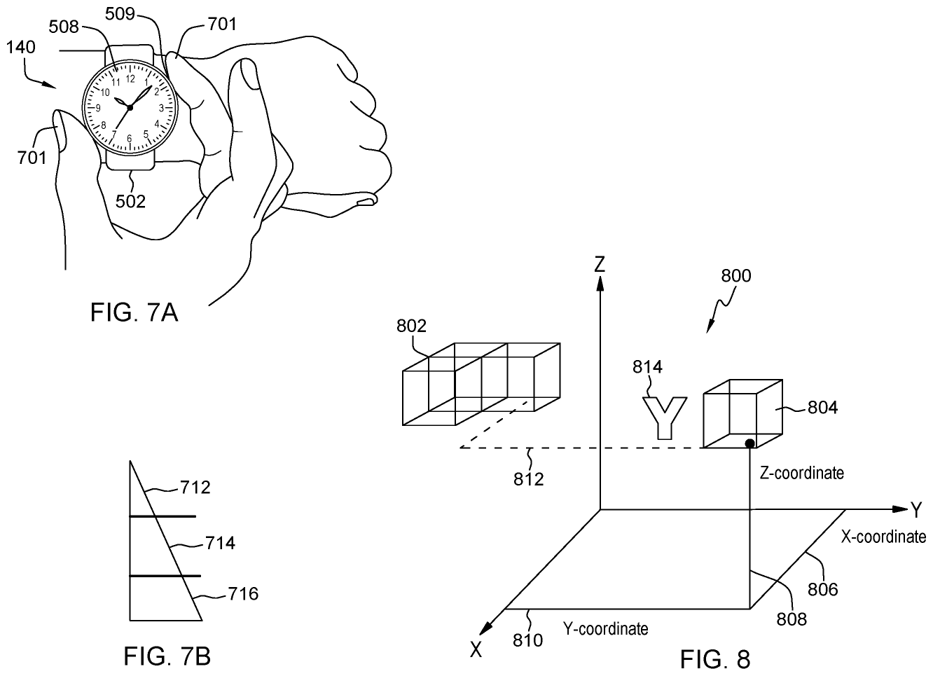

FIGS. 7A and 7B are diagrams illustrating a user capability of controlling the movement of holographic objects, in accordance with embodiments of the present invention. Referring to FIG. 7A now, the wearable device such as watch device 140 may include crown 509 communicatively coupled to the processor of the watch device 140. The crown 509 may be configured to perform a rotational motion. The motions of the crown 509 may be operable to input commands to the processor of the watch device 140. More specifically, users could use their fingers 701 to rotate the crown 509 of the watch device 140 in either clockwise or counterclockwise direction in order to control linear movement of the selected holographic object in a 3D space. Each action performed by the user on the display unit 508 or crown 509 of the watch device 140, such as the direction of rotation (e.g., clockwise or counterclockwise), the speed of rotation, pressing the display unit 508 and/or the crown 509 may correspond to a specific command. Furthermore, the holographic object movement control system 300 may be operable to perform a command selected based on the user input.

In one embodiment, users can define the relationship between the direction of a rotational motion of the crown 509 and a direction of a linear motion of the selected holographic object. For example, clockwise rotation of the crown 509 may be configured to correspond to a linear motion of the holographic object 604 away from the user, while counterclockwise rotation of the crown 509 may be configured to correspond to a linear motion of the holographic object 604 towards the user. In one embodiment, users can define the relationship using the interface 114 of the second device computer 112. In addition, users can utilize the interface 114 to define a ratio between the rotational speed of the crown 509 of the watch device 140 and the linear speed of the holographic object 604, based on the required precision of movement of the holographic object 604. For example, 1:1 ratio may indicate that the linear speed of the holographic object 604 may be about the same as the rotational speed of the crown 509, 1:4 ratio may indicate that the linear speed of the holographic object 604 may be about four times greater than rotational speed of the crown 509, and 4:1 ratio may indicate that the linear speed of the holographic object 604 may be about four times less than rotational speed of the crown 509. In one embodiment, the sensor, which may be integrally formed with the crown 509, may be configured to measure both the direction of rotation and the speed of rotation of the crown 509 of the watch device 140. In some embodiments, the interface 114 may further provide a toggle switch. Users may utilize this toggle switch to provide a physical input to the holographic object movement control system 300 with respect to the orientation change of the holographic object 604. In other words, input received by the sensor of the crown 509 may provide a corresponding user command to the watch device 140, which in turn may inform the holographic object movement control system 300 to change the orientation of the selected holographic object 604.

FIG. 7B illustrates that according to embodiments of the present invention users may be able to dynamically select the direction (an axis) of linear movement of the holographic object 604 within a 3D space by pre-configuring ranges of pressure applied to the crown 509 of the watch device 140. These pressure ranges may be configured using the interface 114, for example. Different types of pressing the crown 509 may correspond to different commands. For example, as shown in FIG. 7B, applied pressure ranging between 1 and 5 units 712 may correspond to user's command to move the holographic object 604 along the X-axis, applied pressure ranging between 5 and 10 units 714 may correspond to user's command to move the holographic object 604 along the Y-axis, and applied pressure having values above 10 units 716 may correspond to user's command to move the holographic object 604 along the Z axis. In one embodiment, once the holographic object movement control system 300 initiates movement of the selected holographic object 604 in one of the user-specified directions, the holographic object movement control system 300 may visually indicate the movement direction along with the projected holographic object 604, as discussed below in conjunction with FIG. 8.

FIG. 8 is a diagram illustrating the user-controlled movement of a holographic object in 3D space, in accordance with embodiments of the present invention. Referring back to an embodiment illustrated in FIG. 3, ideally, at least one holographic projector 302 of the holographic object movement control system 300 installed in the surrounding 3D space projects many 3D holographic objects 802, 804 at the same time. In an alternative embodiment, the plurality of holographic objects 802, 804 may be projected by one or more holography modules 416 of one or more mobile devices 400 shown in FIG. 4. In either embodiment, any user present in the surrounding space who is wearing a watch device 140 connected to the holographic object movement control system 300 should be able to engage with any presented 3D holographic object of interest very quickly using their watch devices 140. It should be noted that the holographic object movement control system 300 knows the 3D coordinates of each of multiple holographic objects 802, 804.

According to an embodiment of the present invention, at any point in time, users can point to one of the many holographic objects 802, 804 and the holographic object movement control system 300 can perform detection of user's selection using the plurality of cameras 303a-303n installed in the surrounding 3D space, for example. Once the selection is made users can move the selected holographic object by inputting their commands via the crown of their watch device 140. For example, if a user selected holographic object 804, by applying a corresponding amount of pressure 712, 714, 716 to the crown 509 of the watch device 140 the user can select one of the axes 806-810 within a 3D space, for example, Y-axis 810. Next, the user can control the movement of the selected holographic object 804 by the direction and speed of the rotation of the crown 509. In one embodiment, a name 814 of the axis 810 selected by the user may be presented as well, for example next to the selected 3D holographic object 804, within the virtual space 800. At least in some embodiments, the holographic object movement control system 300 while moving the selected holographic object 804 in the linear direction selected by the user may also present one or more alignment lines 812 with other holographic objects 802 if it determines a potential target place for the 3D holographic object 804 being relocated. The presented alignment lines 812 enable the user to substantially precisely control the movement of the selected holographic object 804 by using the guided path. In an embodiment, users may be able to toggle between the control of the direction of movement and control of the orientation of the selected holographic object 804. In other words, depending on the selected mode of control, by rotating the crown 509 of the watch device 140, users may be able to change the orientation of the selected holographic object 804.

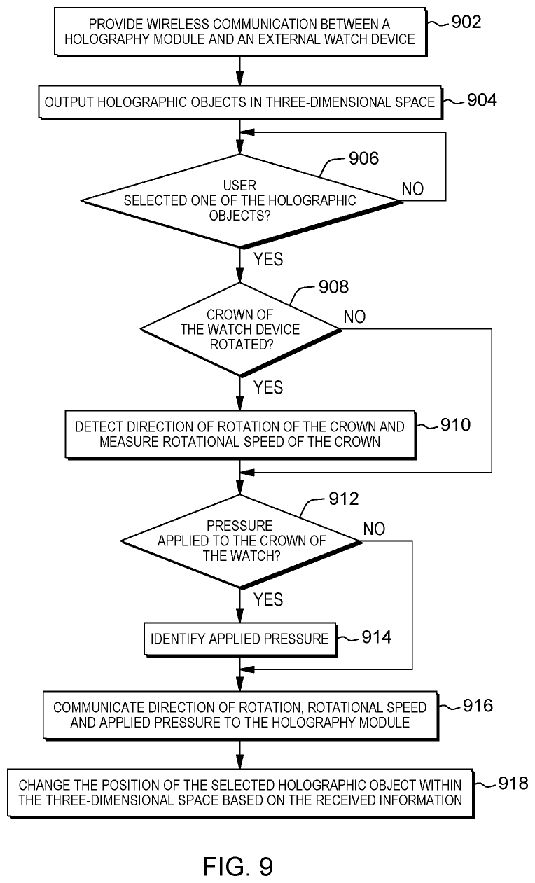

FIG. 9 is a flow diagram of a method for controlling the movement of holographic objects, in accordance with embodiments of the present invention. According to embodiments of the present invention, the wearable device, such as watch device 140, may be configured to exchange data (or be interconnected) with other components of the holographic object movement control system 300, such as holographic projectors 302, mobile devices 400 and/or any other device associated with the holography module 416. A short-range communication module of the holographic object movement control system 300 may sense (or recognize) the wearable device, which can communicate with other components of the system, in the vicinity of those components.

In an embodiment, at block 902, the short-range communication module facilitates short-range communications between the holography module 416 and an external watch device 140. Suitable technologies for implementing such short-range communications include BLUETOOTH™, Radio Frequency Identification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module, in general, supports wireless communications via wireless area networks. One example of the wireless area networks is a wireless personal area network.

At block 904, the holographic object movement control system 300 outputs one or more 3D holographic objects, such as objects 205a-205c illustrated in FIG. 3, holographic object 604 illustrated in FIG. 6 and/or holographic objects 802, 804 shown in FIG. 8. According to embodiments of the present invention, users can select 3D holographic objects they would like to manipulate using their fingers. For example, a 3D holographic object is selected through pointing at the 3D holographic object. Referring back to FIG. 2, in an embodiment, from the extrapolated finger direction of the user (which may be measured by a sensor installed in a watch device 140, for example) for the identified 3D holographic object selected, the holographic object movement control system 300 may plot a holographic intersection line 206 from the fingertip 208 to the 3D holographic object. Software controls the projection of the line from user to the 3D holographic object to visualize what the user is attempting to select. This allows the user to move the finger accordingly until the desired 3D holographic object is selected. The selection could be configured to occur based on time parameter of pointing at an object (i.e. 3 or 5 seconds). The line from the user to the 3D holographic object (single user access) or side of the 3D holographic object (multi-user access) will change color to that of user mapping. Each user may have a defined color mapping such that when they select or manipulate the 3D holographic object, the line from the user to the 3D holographic object is represented as active by showing the color for that user. The line could be configured to pulse or stay solid.

At block 906, the holographic object movement control system 300 continuously monitors if any of the users in the vicinity of the system selected any of the presented 3D holographic objects. In response to determining that one of the users selected one of the presented 3D holographic objects (decision block 906, “Yes” branch), the holographic object movement control system 300 starts communicating with the watch device 140 associated with the user making the selection to determine if the user provides any additional commands to manipulate the selected 3D holographic object. For instance, at block 908, the corresponding watch device 140 determines whether the user initiated a rotation of the crown 509. In response to detecting the rotation of the crown 509 (decision block 908, “Yes” branch), at block 910, watch device 140 may determine the direction of the rotation and measure the rotational speed of the crown 509. Furthermore, in order to move the selected 3D holographic object users may need to apply a corresponding amount of pressure to the crown 509, as described above in conjunction with FIG. 7, to select appropriate axis. Thus, at block 912, the watch device 140 determines if any pressure is applied to the crown 509 of the watch device by the user. If the pressure is applied to the crown (decision block 912, “Yes” branch), at block 914, the watch device 140 may measure the applied pressure to identify the selected axis. Referring to FIG. 8, in one embodiment, a name 814 of the axis 808 selected by the user may be presented as well at block 914.

According to an embodiment of the present invention, at block 916, the watch device 140 communicates user's input, such as but not limited to, the direction of crown 509 rotation, rotational speed and pressure applied to the crown 509 to the holographic object movement control system 300 (e.g., holography module 416). In response to receiving all information related to manipulation of user-selected 3D holographic object, at block 918, the holographic object movement control system 300 changes the position (moves) of the selected 3D holographic object based on the input information received from the user.

FIG. 10 is a block diagram of a computer system 1000 for implementing some or all aspects of the holographic object movement control system 300, according to some embodiments of this invention. The holographic object movement control system 300 and methods described herein may be implemented in hardware, software (e.g., firmware), or a combination thereof. In some embodiments, the methods described may be implemented, at least in part, in hardware and may be part of the microprocessor of a special or general-purpose computer system 1000, such as a personal computer, workstation, minicomputer, or mainframe computer. For instance, the holographic image program 110, interfaces 108 and 114 may each be implemented as a computer system 1000 or may run on a computer system 1000.

In some embodiments, as shown in FIG. 10, the computer system 1000 includes a processor 1005, memory 1010 coupled to a memory controller 1015, and one or more input devices 1045 and/or output devices 1040, such as peripherals, that are communicatively coupled via a local I/O controller 1035. These devices 1040 and 1045 may include, for example, a printer, a scanner, a microphone, and the like. Input devices such as a conventional keyboard 1050 and mouse 1055 may be coupled to the I/O controller 1035. The I/O controller 1035 may be, for example, one or more buses or other wired or wireless connections, as are known in the art. The I/O controller 1035 may have additional elements, which are omitted for simplicity, such as controllers, buffers (caches), drivers, repeaters, and receivers, to enable communications.

The I/O devices 1040, 1045 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 1005 is a hardware device for executing hardware instructions or software, particularly those stored in memory 1010. The processor 1005 may be a custom made or commercially available processor, a central processing unit (CPU), an auxiliary processor among several processors associated with the computer system 1000, a semiconductor-based microprocessor (in the form of a microchip or chip set), a macroprocessor, or other device for executing instructions. The processor 1005 includes a cache 1070, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 1070 may be organized as a hierarchy of more cache levels (L1, L2, etc.).

The memory 1010 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1010 may incorporate electronic, magnetic, optical, or other types of storage media. Note that the memory 1010 may have a distributed architecture, where various components are situated remote from one another but may be accessed by the processor 1005.

The instructions in memory 1010 may include one or more separate programs, each of which comprises an ordered listing of executable instructions for implementing logical functions. In the example of FIG. 10, the instructions in the memory 1010 include a suitable operating system (OS) 1011. The operating system 1011 essentially may control the execution of other computer programs and provides scheduling, input-output control, file and data management, memory management, and communication control and related services.

Additional data, including, for example, instructions for the processor 1005 or other retrievable information, may be stored in storage 1020, which may be a storage device such as a hard disk drive or solid-state drive. The stored instructions in memory 1010 or in storage 1020 may include those enabling the processor to execute one or more aspects of the holographic object movement control system 300 and methods of this disclosure.

The computer system 1000 may further include a display controller 1025 coupled to a display 1030. In some embodiments, the computer system 1000 may further include a network interface 1060 for coupling to a network 1065. The network 1065 may be an IP-based network for communication between the computer system 1000 and an external server, client and the like via a broadband connection. The network 1065 transmits and receives data between the computer system 1000 and external systems. In some embodiments, the network 1065 may be a managed IP network administered by a service provider. The network 1065 may be implemented in a wireless fashion, e.g., using wireless protocols and technologies, such as WiFi, WiMax, etc. The network 1065 may also be a packet-switched network such as a local area network, wide area network, metropolitan area network, the Internet, or other similar type of network environment. The network 1065 may be a fixed wireless network, a wireless local area network (LAN), a wireless wide area network (WAN) a personal area network (PAN), a virtual private network (VPN), intranet or other suitable network system and may include equipment for receiving and transmitting signals.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method for controlling movement of holographic objects, the method comprising:
providing wireless communication between a mobile device having a holography module and a watch device having one or more sensors, the watch device being worn by a user;
outputting, by the holography module of the mobile device, one or more holographic objects in three-dimensional space;
detecting user's selection of one of the holographic objects;
detecting, by the watch device, direction of rotation of a crown of the watch device and measuring rotational speed of the crown of the watch by the watch device;
transmitting, by the watch device to the holography module of the mobile device, the direction of rotation of the crown and the rotational speed of the crown; and
changing position of the selected holographic object, by the holography module of the mobile device, within the three-dimensional space by moving the selected holographic object, wherein direction of movement of the selected holographic object corresponds to the direction of rotation of the crown and wherein speed of the movement of the selected holographic object corresponds to the rotational speed of the crown,
wherein the watch and the mobile device are physically separate devices.

2. The method of claim 1, wherein the direction of rotation of the crown and the rotational speed of the crown are measured by the one or more sensors of the watch device.

3. The method of claim 1, wherein relation between the rotational speed of the crown and the speed of the movement of the selected holographic object is predefined by the user.

4. The method of claim 1, further comprising detecting, by the one or more sensors of the watch device, pressure applied to the crown of the watch and communicating the pressure applied to the holography module.

5. The method of claim 4, wherein the pressure applied indicates an axis within the three-dimensional space along which the selected holographic object is desired to be moved.

6. The method of claim 1, wherein the direction of rotation of the crown indicates a change in orientation of the selected holographic object within the three-dimensional space.

7. The method of claim 1, wherein detecting the user's selection of one of the holographic objects further comprises:
detecting user's finger direction;
extrapolating the detected direction within the three-dimensional space until an intersection with one of the one or more outputted holographic objects found; and
identifying the user's selection based on the intersection within the three-dimensional space.

8. A system for controlling movement of holographic objects, the system comprising:
a memory having computer-readable instructions; and
one or more processors for executing the computer-readable instructions, the computer-readable instructions comprising:
providing wireless communication between a mobile device having a holography module and a watch device having one or more sensors, the watch device being worn by a user;
outputting, by the holography module, one or more holographic objects in three-dimensional space;
detecting user's selection of one of the holographic objects;
detecting, by the watch device, direction of rotation of a crown of the watch device and measuring rotational speed of the crown of the watch by the watch device;
transmitting, by the watch device to the holography module of the mobile device, the direction of rotation of the crown and the rotational speed of the crown; and
changing position of the selected holographic object, by the holography module, within the three-dimensional space by moving the selected holographic object, wherein direction of movement of the selected holographic object corresponds to the direction of rotation of the crown and wherein speed of the movement of the selected holographic object corresponds to the rotational speed of the crown,
wherein the watch and the mobile device are physically separate devices.

9. The system of claim 8, wherein the direction of rotation of the crown and the rotational speed of the crown are measured by the one or more sensors of the watch device.

10. The system of claim 8, wherein relation between the rotational speed of the crown and the speed of the movement of the selected holographic object is predefined by the user.

11. The system of claim 8, the computer-readable instructions further comprising detecting, by the one or more sensors of the watch device, pressure applied to the crown of the watch and communicating the pressure applied to the holography module.

12. The system of claim 11, wherein the pressure applied indicates an axis within the three-dimensional space along which the selected holographic object is desired to be moved.

13. The system of claim 8, wherein the direction of rotation of the crown indicates a change in orientation of the selected holographic object within the three-dimensional space.

14. The system of claim 8, wherein the computer-readable instructions detecting the user's selection of one of the holographic objects further comprise:
detecting user's finger direction;
extrapolating the detected direction within the three-dimensional space until an intersection with one of the one or more outputted holographic objects found; and
identifying the user's selection based on the intersection within the three-dimensional space.

15. A computer-program product for controlling movement of holographic objects, the computer-program product comprising a non-transitory computer-readable storage medium having program instructions embodied therewith, the program instructions executable by a processor to cause the processor to perform a method comprising:
providing wireless communication between a mobile device having a holography module and a watch device having one or more sensors, the watch device being worn by a user;
outputting, by the holography module, one or more holographic objects in three-dimensional space;
detecting user's selection of one of the holographic objects;
detecting, by the watch device, direction of rotation of a crown of the watch device and measuring rotational speed of the crown of the watch by the watch device;
transmitting, by the watch device to the holography module of the mobile device, the direction of rotation of the crown and the rotational speed of the crown; and
changing position of the selected holographic object, by the holography module, within the three-dimensional space by moving the selected holographic object, wherein direction of movement of the selected holographic object corresponds to the direction of rotation of the crown and wherein speed of the movement of the selected holographic object corresponds to the rotational speed of the crown,
wherein the watch and the mobile device are physically separate devices.

16. The computer-program product of claim 15, wherein the direction of rotation of the crown and the rotational speed of the crown are measured by the one or more sensors of the watch device.

17. The computer-program product of claim 15, wherein relation between the rotational speed of the crown and the speed of the movement of the selected holographic object is predefined by the user.

18. The computer-program product of claim 15, the method further comprising detecting, by the one or more sensors of the watch device, pressure applied to the crown of the watch and communicating the pressure applied to the holography module.

19. The computer-program product of claim 18, wherein the pressure indicates an axis within the three-dimensional space along which the selected holographic object is desired to be moved.

20. The computer-program product of claim 15, wherein the direction of rotation of the crown indicates a change in orientation of the selected holographic object within the three-dimensional space.
